(19) United States
(12) Patent Application Publication
(10) Pub. No.: US 2006/0245724 A1
(43) Pub. Date: Nov. 2, 2006

(54) Apparatus and method of detecting advertisement from moving-picture and computer-readable recording medium storing computer program to perform the method

(75) Inventors: Doosun Hwang, Seoul (KR); Kiwan Eom, Seoul (KR); Jiyeun Kim, Seoul (KR); Yongsu Moon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/407,037

(22) Filed: Apr. 20, 2006

(30) Foreign Application Priority Data
Apr. 29, 2005 (KR) 10-2005-0036283

(51) Int. Cl. H04N 7/00

(52) U.S. Cl. 386/95

(57) ABSTRACT

A method of detecting an advertisement in a moving-picture, and an apparatus to perform the method, the method including detecting a component of a visual event from a visual component of the moving-picture, combining or dividing shots based on the component of the visual event, and determining a result obtained by the combination or division of shots as a segment; and detecting an advertisement candidate segment using a rate of shots of the segment; wherein the visual event denotes an effect included in a scene conversion in the moving-picture, the advertisement candidate segment denotes a segment to be a candidate of an advertisement segment, and the advertisement segment denotes a segment having an advertisement as its content.

### CROSS-REFERENCE TO RELATED APPLICATIONS

This application claims the benefit of Korean Patent Application No. 10-2005-0036283, filed on Apr. 29, 2005, in the Korean Intellectual Property Office, the disclosure of which is incorporated herein by reference.

### BACKGROUND OF THE INVENTION

1. Field of the Invention

The present invention relates to a device to process or use television broadcasting signals such as an audio and/or video storage medium, multimedia personal computers, media servers, digital versatile disks (DVDs), recorders, digital televisions, and the like, or a recorded or stored moving-picture, and, more particularly, to an apparatus to detect, and a method of detecting, an advertisement included in a moving-picture, and a computer-readable recording medium storing a computer program to cause the method to be performed.

2. Description of the Related Art

U.S. Pat. Nos. 4,750,052, 4,750,053, and 4,782,401 disclose conventional methods of detecting an advertisement from a moving-picture by using a black frame. However, such conventional methods may erroneously detect a black frame due to fade-in and fade-out effects used to convert scenes into an advertisement section. In addition, since the use of black frame based advertisements has recently decreased, such conventional methods cannot be employed for detecting other types of advertisements.

U.S. Pat. Nos. 6,469,749 and 6,714,594 disclose conventional methods of detecting an advertisement using a high cut rate. However, a high cut rate is difficult to define, and an advertisement from a moving-picture cannot be accurately detected due to a variable high cut rate. To be more specific, there are a variety of advertisements which employ different cut rates, including advertisements having a low cut rate, such as soap opera advertisements, and advertisements having a high cut rate, such as music advertisements.

U.S. Pat. Nos. 5,911,029, 6,285,818, 6,483,987, 2004/0161154, 4,857,999, and 5,668,917 disclose other conventional methods of detecting an advertisement from a moving-picture. However, these conventional methods cannot accurately detect an advertisement in a moving-picture, due to various factors which make it difficult to separate the advertisement from a non-advertisement section.

### SUMMARY OF THE INVENTION

The present invention provides an apparatus to accurately detect an advertisement in a moving-picture using a visual component along with an acoustic factor and subtitle information.

The present invention also provides a method of accurately detecting an advertisement in a moving-picture using a visual component along with an acoustic factor and subtitle information.

The present invention also provides a computer-readable recording medium storing a computer program to control the apparatus to detect an advertisement from a moving-picture.

Additional aspects and/or advantages of the invention will be set forth in part in the description which follows and, in part, will be apparent from the description, or may be learned by practice of the invention.

According to an aspect of the present invention, there is provided an apparatus to detect an advertisement in a moving-picture, the apparatus comprising: a segment generator to detect a component of a visual event from a visual component of the moving-picture, to combine or divide shots based on the component of the visual event, and to output a result obtained by the combination or division of shots as a segment; and an advertisement candidate segment detector to detect an advertisement candidate segment using a rate of shots of the segment; wherein the visual event denotes an effect included in a scene conversion in the moving-picture, the advertisement candidate segment denotes a segment to be a candidate of an advertisement segment, and the advertisement segment denotes a segment having an advertisement as its content.

According to another aspect of the present invention, there is provided a method of detecting an advertisement in a moving-picture, the method comprising: detecting a component of a visual event from a visual component of the moving-picture, combining or dividing shots based on the component of the visual event, and determining a result obtained by the combination or division of shots as a segment; and detecting an advertisement candidate segment using a rate of shots of the segment; wherein the visual event denotes an effect included in a scene conversion in the moving-picture, the advertisement candidate segment denotes a segment to be a candidate of an advertisement segment, and the advertisement segment denotes a segment having an advertisement as its content.

According to still another aspect of the present invention, there is provided at least one computer readable medium storing instructions that control at least one processor to perform a method of detecting an advertisement in a moving-picture, wherein the method comprises: detecting a component of a visual event from a visual component of the moving-picture, combining or dividing shots based on the component of the visual event, and determining a result obtained by the combination or division of shots as a segment; and detecting an advertisement candidate segment using a rate of shots of the segment; wherein the visual event denotes an effect included in a scene conversion in the moving-picture, the advertisement candidate segment denotes a segment to be a candidate of an advertisement segment, and the advertisement segment denotes a segment having an advertisement as its content.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an apparatus to detect an advertisement from a moving-picture according to an embodiment of the present invention;

FIG. 2 is a flowchart illustrating a method of detecting an advertisement from a moving-picture according to an embodiment of the present invention;

FIG. 3 is a block diagram illustrating a segment generator shown in FIG. 1 according to an embodiment of the present invention;

FIG. 4 is a flowchart illustrating Operation 20 shown in FIG. 2 according to an embodiment of the present invention;

FIGS. 5A and 5B are graphs illustrating an operation of a visual event detector shown in FIG. 3;

FIG. 6 is a block diagram illustrating a visual shot combiner/divider shown in FIG. 3 according to an embodiment of the present invention;

FIGS. 7A through 7F are diagrams illustrating the visual shot combiner/divider shown in FIG. 3;

FIGS. 8A through 8C are diagrams illustrating the operation of a visual shot combiner/divider shown in FIG. 6;

FIG. 9 is a block diagram illustrating an advertisement candidate segment detector shown in FIG. 1 according to an embodiment of the present invention;

FIG. 10 is a flowchart illustrating Operation 22 shown in FIG. 2 according to an embodiment of the present invention;

FIG. 11 is a diagram illustrating an operation of an advertisement candidate segment output unit;

FIG. 12 is a block diagram illustrating an acoustic shot characteristics extractor shown in FIG. 2 according to an embodiment of the present invention;

FIG. 13 is a flowchart illustrating Operation 24 shown in FIG. 2 according to an embodiment of the present invention;

FIG. 14 is a block diagram illustrating an audio characterizing value generator shown in FIG. 12 according to an embodiment of the present invention;

FIG. 15 is a block diagram illustrating an advertisement segment determiner shown in FIG. 1 according to an embodiment of the present invention;

FIG. 16 is a flowchart illustrating Operation 26 shown in FIG. 2 according to an embodiment of the present invention;

FIG. 17 is a block diagram illustrating the advertisement segment determiner shown in FIG. 1 according to another embodiment of the present invention;

FIG. 18 is a flowchart illustrating Operation 26 shown in FIG. 2 according to another embodiment of the present invention;

FIG. 19 is a block diagram illustrating an apparatus to detect an advertisement from a moving-picture according to an embodiment of the present invention;

FIG. 20 is a block diagram illustrating an apparatus to detect an advertisement from a moving-picture according to another embodiment of the present invention; and

FIGS. 21 through 23 are tables illustrating the performance of the apparatus to detect, and method of detecting, an advertisement from a moving-picture according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

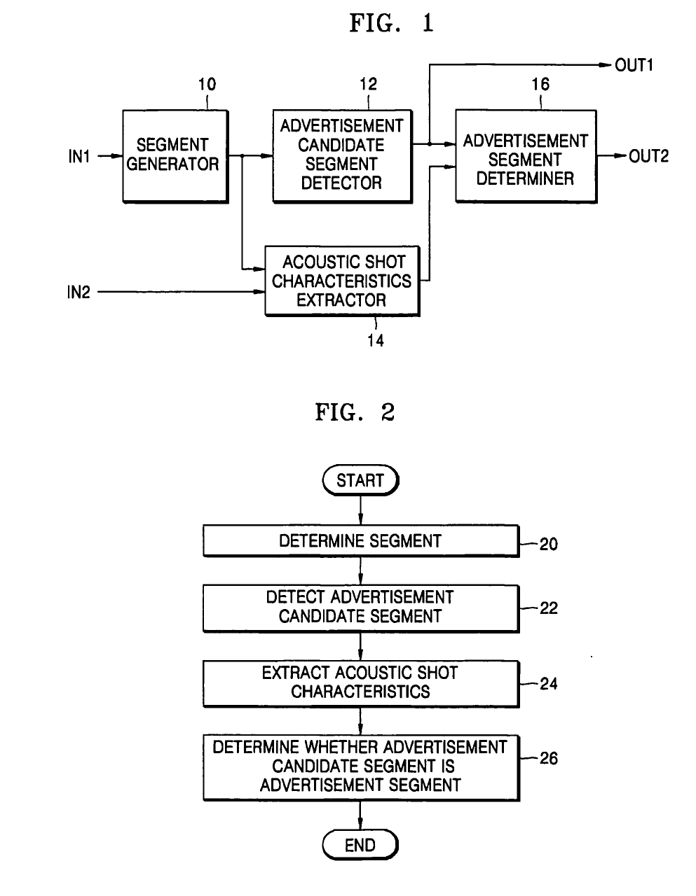

FIG. 1 is a block diagram illustrating an apparatus to detect an advertisement from a moving-picture according to an embodiment of the present invention. Referring to FIG. 1, the apparatus according to this embodiment includes a segment generator 10, an advertisement candidate segment detector 12, an acoustic shot characteristics extractor 14, and an advertisement segment determiner 16.

FIG. 2 is a flowchart illustrating a method of detecting an advertisement from a moving-picture according to an embodiment of the present invention. The method according to this embodiment includes a determination of a segment (Operation 20), detection of an advertisement candidate segment (Operation 22), extraction of acoustic shot characteristics (Operation 24), and determination of whether the advertisement candidate segment is an advertisement segment (Operation 26).

The apparatus to detect the advertisement from a moving-picture illustrated in FIG. 1 may also incorporate only the segment generator 10 and advertisement candidate segment detector 12 in alternative embodiments of the present invention. Similarly, the method of detecting the advertisement from a moving-picture illustrated in FIG. 2 may only incorporate Operations 20 and 22 in alternative embodiments. In this case, Operations 20 and 22 can be performed by the segment generator 10 and advertisement candidate segment detector 12, respectively.

The segment generator 10 receives a visual component of a moving-picture via an input terminal IN1, detects a component of a visual event from the input visual component of the moving-picture, combines or divides shots based on the detected component of the visual event, and outputs the result obtained by the combination or division of shots as a segment (Operation 20). The visual component of the moving-picture may include time and color information of shots included in the moving-picture, time information of a fade frame, and the like. The visual event may include a graphic effect intentionally included in a conversion of content in the moving-picture. Therefore, generation of the visual event results in a conversion of content. The visual event may be, for example, a fade effect, a dissolve effect, or a wipe effect.

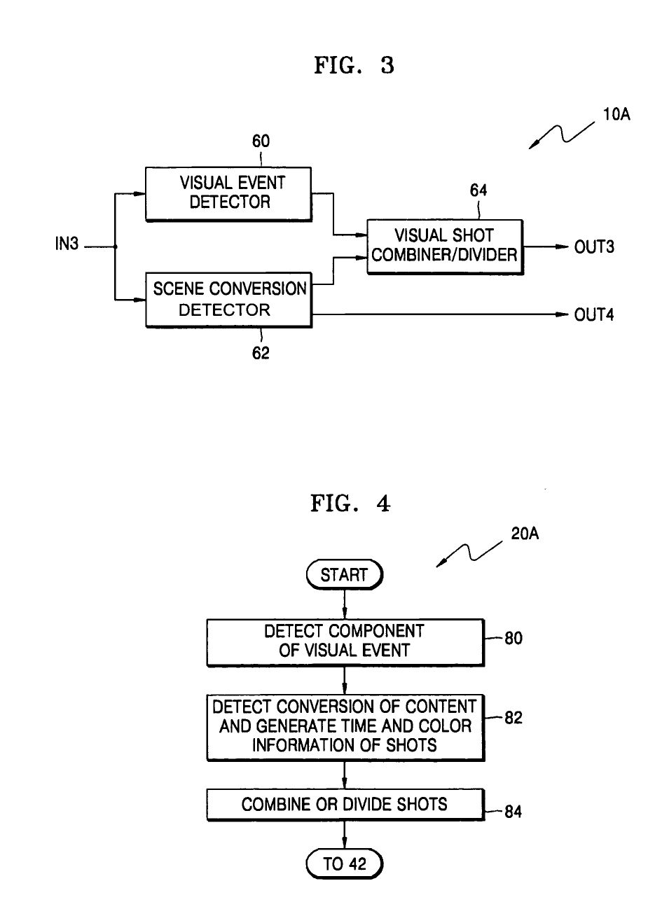

FIG. 3 is a block diagram illustrating the segment generator shown in FIG. 1 according to an embodiment of the present invention. Referring to FIG. 3, the segment generator 10A includes a visual event detector 60, a scene conversion extractor 62, and a visual shot combiner/divider 64.

FIG. 4 is a flowchart illustrating Operation 20 shown in FIG. 2 according to an embodiment of the present invention. The flowchart includes detection of a component of the visual event (Operation 80), generation of time and color information of shots (Operation 82), and a combination or division of shots (Operation 84).

The visual event detector 60 receives a visual component of the moving-picture via an input terminal IN3, detects a visual event component from the input visual component, and outputs the detected visual event component to the shot combiner/divider 64 (Operation 80).

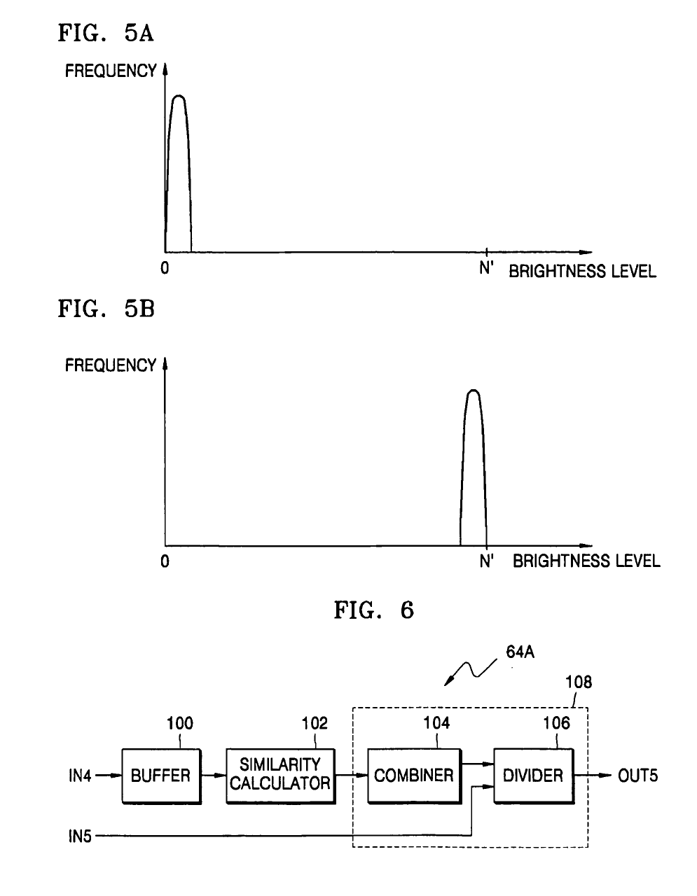

FIGS. 5A and 5B are graphs illustrating an operation of the visual event detector 60 shown in FIG. 3. Each graph has a horizontal axis indicating a brightness level, with N′ denoting the largest value of the brightness level, and a vertical axis indicating a frequency.

The visual event may be assumed to be a fade effect for a better understanding of the present invention. In view of the fade effect, frames between a fade-in frame and a fade-out frame have a single color frame inserted between. Both fade-in frame and fade-out frame are examples of the fade frame mentioned above. Therefore, the visual event detector 60 can detect the single color frame inserted between the fade-in or fade-out frame of the fade effect using a color histogram of a visual component included in the moving-picture, and output the detected single color frame as a component of the visual event. For example, the single color frame may be a black frame, as indicated in FIG. 5A, or a white frame, as indicated in FIG. 5B.

After Operation 80 is performed, the scene conversion detector 62 receives the visual component of the moving-picture via the input terminal IN3, detects a scene conversion from the input visual component, outputs the detected scene conversion to the advertisement candidate segment detector 12 via an output terminal OUT4, generates time and color information of a section of the same scene using the result obtained by the detection of the scene conversion, and outputs the generated time and color information of the section of the same scene to the shot combiner/divider 64 (Operation 82). The section of the same scene is called a shot, which comprises a group of frames included in the scene conversion, i.e., a plurality of frames occurring from a frame at which a scene is converted to a frame at which a new scene is converted. In this case, the scene conversion detector 62 selects a single or a plurality of representative image frames from each shot, and outputs time and color information of the selected representative image frame(s). The method of detecting the scene conversion from the visual component of the motion-picture performed by the scene conversion detector 62 is disclosed in U.S. Pat. Nos. 5,767,922, 6,137,544, and 6,393,054.

According to alternative embodiments of the present invention, Operation 82 may be performed before Operation 80, or both Operations 80 and 82 may be simultaneously performed, which is different from the flowchart illustrated in FIG. 4.

After Operation 82 is performed, the visual shot combiner/divider 64 analyzes the similarity of the shots using the color information of the shots received from the scene conversion detector 62, combines or divides the shots using the analyzed similarity and the component of the visual event input from the visual event detector 60, and outputs the result obtained by the combination or division of the shots as a segment via the output terminal OUT3 (Operation 84).

FIG. 6 is a block diagram illustrating the visual shot combiner/divider 64 shown in FIG. 3 according to an embodiment of the present invention. The visual shot combiner/divider 64A includes a buffer 100, a similarity calculator 102, a combiner 104, and a divider 106.

The buffer 100 stores color information of the shots received from the scene conversion detector 62 via an input terminal IN4.

The similarity calculator 102 reads color information pertaining to a search window among the color information stored in the buffer 100, calculates color similarity of the shots using the read color information, and outputs the calculated color similarity to the combiner 104. The size of the search window, i.e., the number of shots included in the search window, is a first predetermined number determined according to EPG (Electronic Program Guide) information. According to this embodiment of the present invention, the similarity calculator 102 calculates the color similarity as shown in Equation 1:

$$Sim ( {H}_{1} , {H}_{2} ) = {\sum }_{n = 1}^{N} min [ {H}_{1} ( n ) , {H}_{2} ( n ) ] \qquad ( 1 )$$

wherein Sim (H1, H2) denotes the color similarity calculated using the color information of two shots H1 and H2 input from the scene conversion detector 62, H1(n) and H2(n) denote color histograms of the two shots, respectively, N denotes a histogram level, and min(x,y) denotes a minimum value between x and y in a conventional color histogram intersection method.

The combiner 104 compares the color similarity calculated in the similarity calculator 102 and a threshold value, and combines the compared two shots in response to the result obtained by the comparison of the two shots. If, for example, the color similarity is more than the threshold value, the two shots can be combined.

In this regard, the visual shot combiner/divider 64A further includes the divider 106. When the component of the visual event is received from the visual event detector 60 via an input terminal IN5, i.e., when the result obtained by the combination of the two shots in the combiner 104 has the component of the visual event, the divider 106 divides the result obtained by the combination of the two shots in the combiner 104 based on the component of the visual event, and outputs the result obtained by the division as a segment via an output terminal OUT5.

According to an embodiment of the present invention, the visual shot combiner/divider 64A may separately include the combiner 104 and the divider 106 as illustrated in FIG. 6. In this case, the combination operation is performed before the division operation.

According to another embodiment of the present invention, the visual shot combiner/divider 64A may include a combiner/divider 108 which is a combination of the combiner 104 and the divider 106. In this connection, the combiner/divider 108 finally determines shots to be combined and divided, and combines the shots that are determined to be combined.

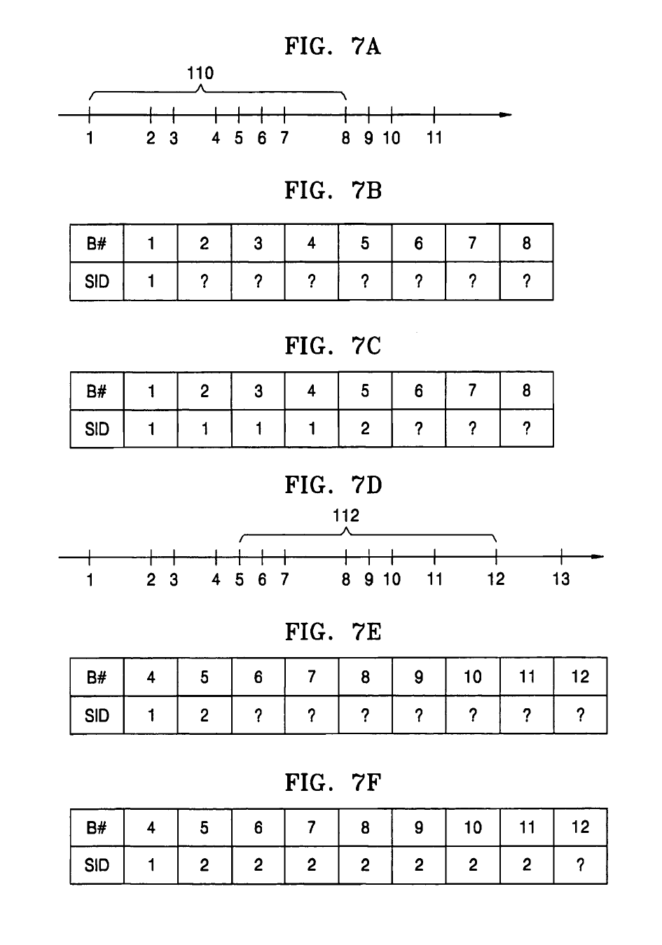

FIGS. 7A through 7F are diagrams illustrating the visual shot combiner/divider 64 shown in FIG. 3. FIGS. 7A and 7D illustrate time-elapsed orders of serial shots in the arrow direction. FIGS. 7B, 7C, 7E, and 7F are tables illustrating the matching of the buffer 100 and a segment identification number SID. In the tables, B# denotes a buffer number, i.e., a shot number, and the identifier “?” denotes indetermination of the SID.

For a better understanding of the present invention, the size of the search window, i.e. the first predetermined number, is determined to be 8 for this discussion, but the search window size is not limited thereto.

In case of combining or dividing shots 1˜8 included in a search window 110 illustrated in FIG. 7A, suppose that the SID of a first buffer (B#=1) is 1, for the sake of convenience, as illustrated in FIG. 7B. In this case, the similarity calculator 102 compares color information of a shot stored in the first buffer (B#=1) and color information of shots stored in a second buffer (B#=2) through eighth buffer (B#=8), comparing two shots at a time, and calculates similarities of the compared two shots.

For example, the similarity calculator 102 can check the similarity of two shots from different ends of the range of buffers. To be more specific, suppose that the similarity calculator 102 compares the color information stored in the first buffer (B#=1) and the color information stored in the eighth buffer (B#=8), compares the color information stored in the first buffer (B#=1) and the color information stored in the seventh buffer (B#=7), compares the color information stored in the first buffer (B#=1) and the color information stored in the sixth buffer (B#=6), and the like.

Under such circumstances, if the combiner/divider 108 determines that the color similarity Sim(H1,H8) between the first buffer (B#=1) and the eighth buffer (B#=8) calculated in the similarity calculator 102 is lower than the threshold, the combiner/divider 108 determines if the color similarity Sim(H1,H7) between the first buffer (B#=1) and the seventh buffer (B#=7) calculated in the similarity calculator 102 is higher than the threshold. If the color similarity Sim(H1,H7) between the first buffer (B#=1) and the seventh buffer (B#=7) calculated in the similarity calculator 102 is determined to be higher than the threshold, all SIDs of the first buffer (B#=1) to the seventh buffer (B#=7) are established as 1. In this case, color similarity between each of the second buffer (B#=2) to the sixth buffer (B#=6) and the first buffer (B#=1) is not calculated. Therefore, the combiner/divider 108 combines a first shot to a seventh shot that have the same SID.

However, suppose that a black frame is included in a fourth shot to make the visual event, i.e., the fade effect. In this regard, when the combiner/divider 108 receives the component of the visual event from the event detector 60 via the input terminal IN5, the SIDs of the first buffer (B#=1) to the fourth buffer (B#=4) are all 1, and the SID of the fifth buffer (B#=5) is 2 as illustrated in FIG. 7C. At this time, the combiner/divider 108 combines the first shot to the fourth shot that have the same SID.

The combiner/divider 108 checks whether to combine or divide shots 1˜12 included in the search window 112 illustrated in FIG. 7D based on the fifth shot. The SIDs of the fifth shot to a twelfth shot included in the search window 112 in an initial state are illustrated in FIG. 7E.

When the combiner/divider 108 determines that the color similarity Sim(H5,H12) between color information of the fifth buffer (B#=5) and color information of the twelfth buffer (B#=12) calculated in the similarity calculator 102 is lower than the threshold, the combiner/divider 108 determines if the color similarity Sim(H5,H11) between the color information of the fifth buffer (B#=5) and color information of the eleventh buffer (B#=11) calculated in the similarity calculator 102 is higher than the threshold. If the color similarity Sim(H5,H11) is determined to be higher than the threshold, all SIDs of the fifth buffer (B#=5) to the eleventh buffer (B#=11) are established as 2 as illustrated in FIG. 7F. In this case, when there is no visual event, the combiner/divider 108 combines a fifth shot to an eleventh shot that have the same SID, i.e., 2.

The visual shot combiner/divider 64 performs the above operations until it obtains the SID of each B# stored in the buffer 100, i.e. every shot, using the color information regarding the shots stored in the buffer 100.

FIGS. 8A through 8C are diagrams illustrating the operation of the visual shot combiner/divider 64A shown in FIG. 6, in which horizontal axes indicate time.

Suppose that the combiner 104 combines shots 101, 103, 105, 119, 107, 109, and 111 of FIG. 8A as shown in FIG. 8B. When the shot 119 interposed in a segment 114 comprising combined shots includes a black frame, i.e., a component of a visual event used to produce the fade effect, the divider 106 divides the segment 114 into two segments 116 and 118 based on the shot 119 having the component of the visual event input via the input terminal IN5.

After Operation 20 is performed, the advertisement candidate segment detector 12 detects an advertisement candidate segment using a rate of shots included in the segment generated in the segment generator 10, and outputs the detected advertisement candidate segment to the advertisement segment determiner 16 (Operation 22). The advertisement candidate segment indicates a segment to be a candidate of an advertisement segment. The advertisement segment indicates a segment having an advertisement as its content. When the apparatus used to detect an advertisement from the moving-picture illustrated in FIG. 1 is realized as only the segment generator 10 and the advertisement candidate segment detector 12, the advertisement candidate segment detector 12 outputs the detected advertisement candidate segment only via an output terminal OUT1, instead of outputting it to the advertisement segment determiner 16.

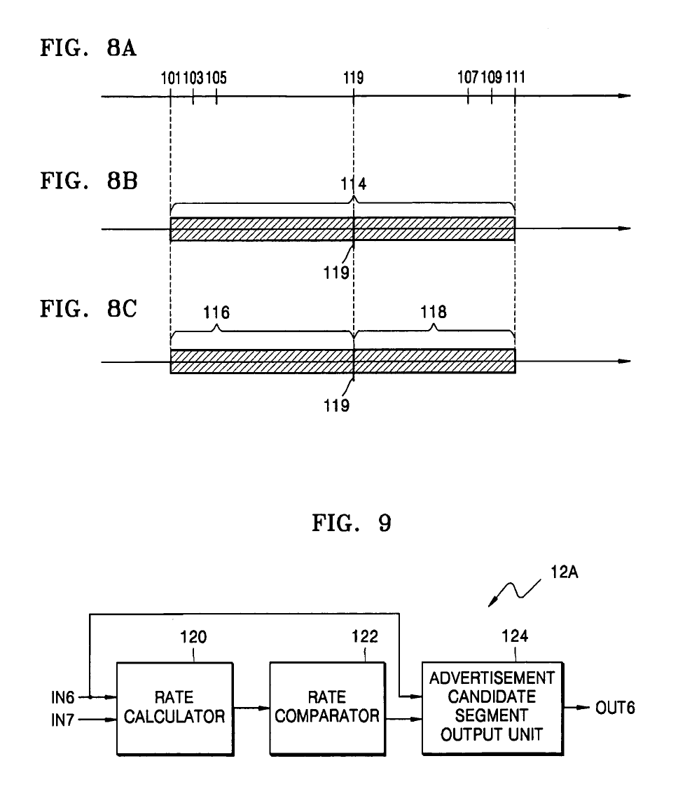

FIG. 9 is a block diagram illustrating the advertisement candidate segment detector 12 shown in FIG. 1 according to an embodiment of the present invention. The advertisement candidate segment detector 12 includes a rate calculator 120, a rate comparator 122, and an advertisement candidate segment output unit 124.

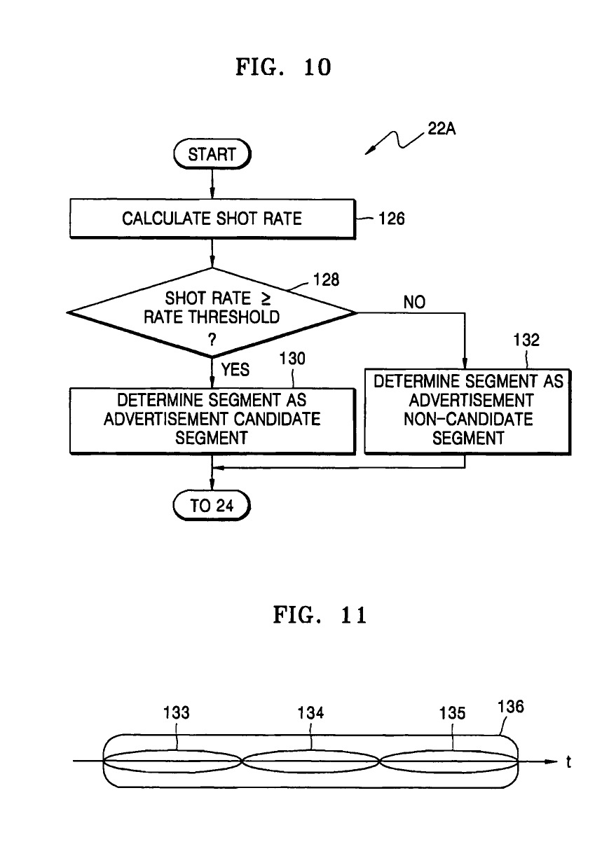

FIG. 10 is a flowchart illustrating Operation 22 shown in FIG. 2 according to an embodiment of the present invention. The flowchart includes calculation of a shot rate and comparison of the calculated shot rate with a rate threshold (Operations 126 and 128), and determination of whether a segment is an advertisement candidate segment (Operations 130 and 132).

The rate calculator 120 calculates a rate of shots included in the segment received from the segment generator 10 via an input terminal IN6 using the scene conversion detected in the scene conversion detector 62 illustrated in FIG. 3 as shown below in Equation 2, and outputs the calculated shot rate to the rate comparator 122 (Operation 126). To this end, the rate calculator 120 receives the scene conversion from the scene conversion detector 62 via an input terminal IN7. Equation 2 is shown as:

$$SCR = \frac{S}{N \#} \qquad ( 2 )$$

wherein SCR(Shots Change Rate within the segment shot) denotes a shot rate, S denotes a number of shots included in the segment generated in the segment generator 10, which is obtained using the scene conversion, and N# denotes a number of frames included in the segment generated in the segment generator 10.

After Operation 126 is performed, the rate comparator 122 compares the shot rate calculated in the rate calculator 120 and the rate threshold, and outputs the result obtained by the comparison to the advertisement candidate segment output unit 124 (Operation 128). The rate comparator 122 determines whether the shot rate is higher than the rate threshold.

The advertisement candidate segment output unit 124 determines the segment input to the rate calculator, i.e., the segment received from the segment generator 10 via the input terminal IN6, as an advertisement candidate segment in response to the result obtained by the comparison in the rate comparator 122, and outputs the determined advertisement candidate segment via an output terminal OUT6 (Operation 130).

For example, if the advertisement candidate segment output unit 124 determines that the shot rate is higher than the rate threshold based on the result obtained by the comparison in the rate comparator 122, it determines the segment used for calculating the shot rate to the advertisement candidate segment. However, if the advertisement candidate segment output unit 124 determines that the shot rate is lower than the rate threshold based on the result obtained by the comparison in the rate comparator 122, it determines the segment used for calculating the shot rate to be an advertisement non-candidate segment (Operation 132).

According to this embodiment of the present invention, the advertisement candidate segment output unit 124 may combine or extend advertisement candidate segments.

According to another embodiment of the present invention, the advertisement candidate segment output unit 124 may combine successive advertisement candidate segments.

According to another embodiment of the present invention, when an advertisement non-candidate segment is included in advertisement candidate segments, the advertisement non-candidate segment is regarded as an advertisement candidate segment, and the region of the advertisement candidate segment can be extended. The advertisement non-candidate segment indicates a segment which is not a candidate of an advertisement segment. The present embodiment can be usefully applied to extend a region of an advertisement candidate segment after checking, less frequently, predetermined segments of a broadcasting moving-picture including a successive plurality of advertisements.

FIG. 11 is a diagram illustrating an operation of the advertisement candidate segment output unit 124. This operation of the advertisement candidate segment output unit 124 involves three segments 133, 134, and 135.

When the segments 133, 134, and 135 are advertisement candidate segments, the advertisement candidate segment output unit 124 combines and outputs the successive advertisement candidate segments 133, 134, and 135.

Suppose that the segments 133 and 135 are advertisement candidate segments and the segment 134 interposed between the segments 133 and 135 is an advertisement non-candidate segment. While the advertisement non-candidate segment 134 is regarded as an advertisement candidate segment, the advertisement candidate segment output unit 124 combines the advertisement non-candidate segment 134 and the advertisement candidate segments 133 and 135 and actually extends the region of the advertisement candidate segment 136.

The apparatus used to detect the advertisement from the moving-picture illustrated in FIG. 1 may further include the acoustic shot characteristics extractor 14 and the advertisement segment determiner 16. In this case, the method of detecting the advertisement from the moving-picture illustrated in FIG. 2 may further include Operations 24 and 26, which are performed in the acoustic shot characteristics extractor 14 and the advertisement segment determiner 16, respectively.

After Operation 22 is performed, the acoustic shot characteristics extractor 14 receives an acoustic component of the moving-picture via the input terminal IN2, detects a component of an acoustic event from the input acoustic component, extracts characteristics of an acoustic shot using the detected component of the acoustic event and the segment generated in the segment generator 10, and outputs the detected characteristics of the acoustic shot to the advertisement segment determiner 16 (Operation 24). Herein, the acoustic event denotes a type of sound that classifies the acoustic component, and the component of the acoustic event may be, for example, at least one of music, voice, surrounding noise, and mute.

According to other embodiments of the present invention, Operation 24 may be performed before Operation 22 is performed, or both Operations 22 and 24 can be simultaneously performed, which is different from the flowchart illustrated in FIG. 2.

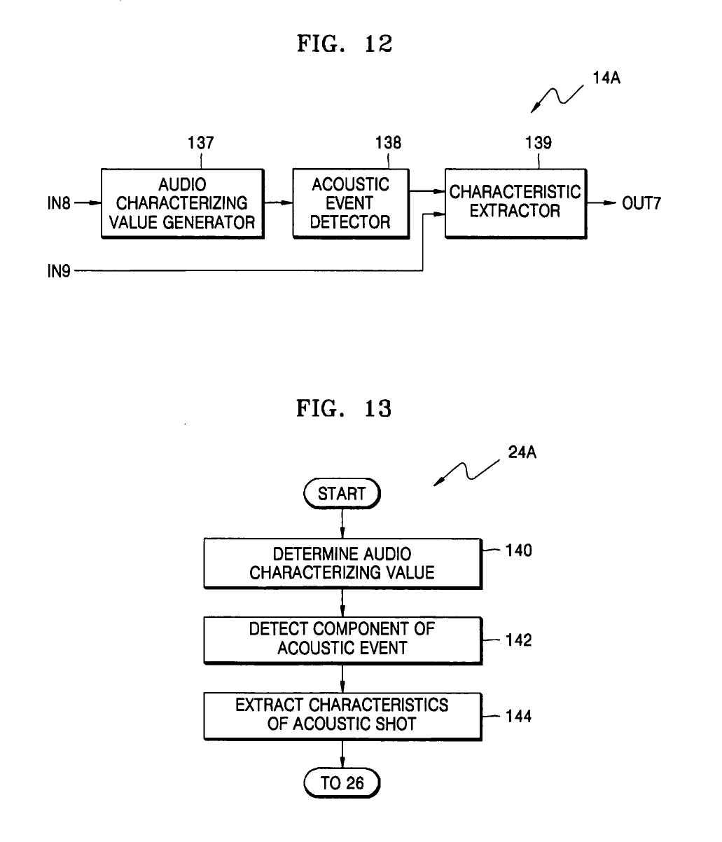

FIG. 12 is a block diagram illustrating the acoustic shot characteristics extractor 14 shown in FIG. 2 according to an embodiment of the present invention. The acoustic shot characteristics extractor 14 includes an audio characterizing value generator 137, an acoustic event detector 138, and a characteristic extractor 139.

FIG. 13 is a flowchart illustrating Operation 24 shown in FIG. 2 according to an embodiment of the present invention. The flowchart includes determination of an audio characterizing value (Operation 140), detection of a component of an acoustic event (Operation 142), and extraction of characteristics of an acoustic shot (Operation 144).

The audio characterizing value generator 137 receives an acoustic component of the moving-picture via an input terminal IN8, extracts audio features from the input acoustic component by frames, and outputs an average and a standard deviation of the audio features of a second integer number of frames to the acoustic event detector 138 as audio characterizing values (Operation 140). The audio features may be, for example, MFCC(Mel-Frequency Cepstral Coefficient), Spectral Flux, Centroid, Rolloff, ZCR, Energy, or Picth information. The second predetermined number is an integral number larger than 2, e.g., 40.

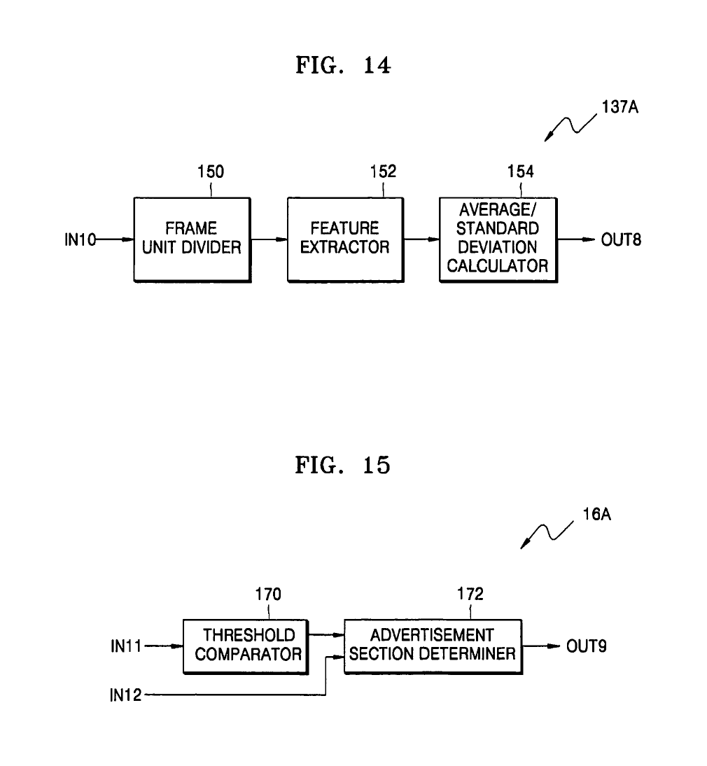

FIG. 14 is a block diagram illustrating the audio characterizing value generator 137 shown in FIG. 12. The audio characterizing value generator 137A includes a frame unit divider 150, a feature extractor 152, and an average/standard deviation calculator 154.

The frame unit divider 150 divides an input acoustic component of the moving-picture received via an input terminal IN10 by a predetermined time of a frame unit, e.g., 24 ms. The feature extractor 152 extracts an audio feature of each of the divided acoustic components. The average/standard deviation calculator 154 calculates an average and a standard deviation of the second integer number of the audio features extracted from the feature extractor 152 of the second integer number of frames, determines the calculated average and standard deviation as audio characterizing values, and outputs the determined audio characterizing values via an output terminal OUT8.

Some methods among conventional methods of generating an audio characterizing value from an acoustic component of moving-picture are disclosed in U.S. Pat. No. 5,918,223 entitled “Method and Article of Manufacture for Content-Based Analysis, Storage, Retrieval and Segmentation of Audio Information”, U.S. Patent Application No. 20030040904 entitled “Extracting Classifying Data in Music from an Audio Bitstream”, the article “Audio Feature Extraction and Analysis for Scene Segmentation and Classification” by Zhu Liu, Yao Wang, and Tsuhan Chen, Journal of VLSI Signal Processing Systems archive Volumn 20 (pages 61˜79, 1998), and the article “SVM-based Audio Classification for Instructional Video Analysis” by Ying Li and Chitra Dorai, ICASSP 2004.

After Operation 140 is performed, the acoustic event detector 138 detects a component of an audio event using the audio characterizing values input from the audio characterizing value generator 137, and outputs the detected component of the audio event to the characteristic extractor 139 (Operation 142).

A variety of statistical learning models such as, for example, GMM (Gaussian Mixture Model), HMM (Hidden Markov Model), NN (Neural Network) or SVM (Support Vector Machine) may be used as some conventional methods of detecting components of an acoustic event from an audio characterizing value. A conventional method of detecting an acoustic event using the SVM is disclosed in the article “SVM-based Audio Classification for Instructional Video Analysis” by Ying Li and Chitra Dorai, ICASSP2004.

After Operation 142 is performed, the characteristic extractor 139 extracts characteristics of an acoustic shot using the component of the acoustic event detected in the acoustic event detector 138 and the segment generated in the segment generator 10 and received via the input terminal IN9, and outputs the extracted characteristics of the acoustic shot to the advertisement segment determiner 16 via an output terminal OUT7 (Operation 144).

The characteristic extractor 139 illustrated in FIG. 12 can determine at least one of a rate of the component of the acoustic event, a portion of music among components of the acoustic event, and a maximum time duration of a sequence comprising components of the same acoustic event such as characteristics of the acoustic shot in segment units, i.e., unit time, generated in the segment generator 10.

The characteristic extractor 139 calculates the rate of the component of the acoustic event in the segment unit generated in the segment generator 10 as shown below in Equation 3. For example, in case in which a component of the acoustic event is music, voice, surrounding noise, and mute, their rates can be calculated as:

$$ACCR = \frac{{\sum }_{j = 2}^{J} H [ C ( j ) , C ( j - 1 ) ]}{J} \qquad ( 3 )$$

wherein ACCR (Audio Class Change Rate within the segment shot) denotes the rate of the component of the acoustic event detected in the acoustic event detector 138, and J denotes the number of audio clips included in the segment generated in the segment generator 10. A clip is a minimum unit classified as an acoustic component, e.g., about 1 second. C(j) denotes a type of components of the acoustic event of a j^{th} audio clip. In this case, H[C(j), C(j−1)] is calculated as shown below in Equation 4:

$$H [ C ( j ) , C ( j - 1 ) ] = \{ \begin{matrix}1 , & C ( j ) \neq C ( j - 1 ) \\ 0 , & C ( j ) = C ( j - 1 )\end{matrix} \qquad ( 4 )$$

Further, the characteristic extractor 139 calculates the portion of music among components of the acoustic event in the segment unit generated in the segment generator 10 as shown below in Equation 5:

$$MCR = \frac{{\sum }_{j = 1}^{J} SM [ C ( j ) , '' Music '' ]}{J} \qquad ( 5 )$$

wherein MCR (Music Class Ratio within the segment shot) denotes the portion of music among components of the acoustic event, and M denotes the number of sequences comprising components of the same acoustic event included in the segment generated in the segment generator 10. SM[C(j), “Music”] is calculated as shown below in Equation 6:

$$SM [ C ( j ) , '' Music '' ] = \{ \begin{matrix}1 , & C ( j ) = '' Music '' \\ 0 , & C ( j ) \neq '' Music ''\end{matrix} \qquad ( 6 )$$

Further, the characteristic extractor 139 calculates the maximum time duration of the sequence comprising components of the same acoustic event included in the segment generated in the segment generator 10 as shown below in Equation 7:

$$MDS = \frac{{max}_{1 \leq m \leq M} [ {d}_{s} ( m ) ]}{J} \qquad ( 7 )$$

wherein MDS (Max-Duration of the Sequence with same audio classes within the segment shot) denotes the maximum time duration of the sequence comprising components of the same acoustic event, and ds(m) denotes the number of audio clips of an m^{th} sequence.

After Operation 24 is performed, the advertisement segment determiner 16 determines whether the advertisement candidate segment detected in the advertisement candidate segment detector 12 is an advertisement segment using the characteristics of the acoustic shot extracted in the acoustic shot characteristic extractor 14, and outputs the results obtained by the determination via the output terminal OUT2 (Operation 26).

FIG. 15 is a block diagram illustrating the advertisement segment determiner 16 shown in FIG. 1 according to an embodiment of the present invention. The advertisement segment determiner 16A includes a threshold comparator 170 and an advertisement section determiner 172.

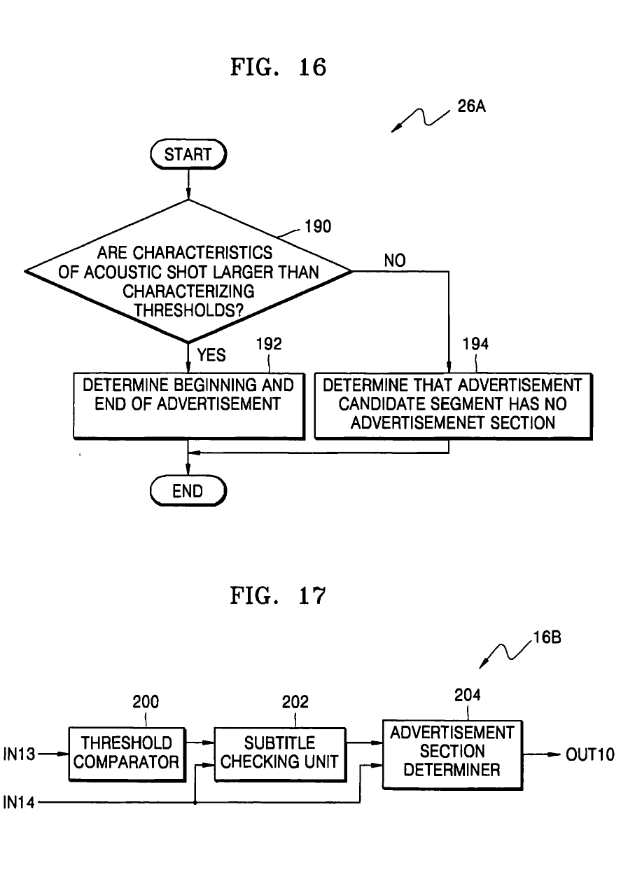

FIG. 16 is a flowchart illustrating Operation 26 shown in FIG. 2 according to an embodiment of the present invention. The flowchart includes determining a beginning and end of an advertisement based on the comparison of characteristics of an acoustic shot and characterizing thresholds (Operations 190 through 194). The threshold comparator 170 compares the characteristics of the acoustic shot extracted from the acoustic shot characteristic extractor 14 with the characterizing thresholds received via an input terminal IN11, and outputs the results obtained by the comparison to the advertisement section determiner 172 (Operation 190). That is, the threshold comparator 170 determines whether the extracted characteristics of the acoustic shot are larger than the characterizing thresholds.

The advertisement section determiner 172 determines whether the advertisement candidate segment received from the advertisement candidate segment detector 12 via the input terminal IN12 is an advertisement segment in response to the result obtained by the comparison, and determines the beginning (frame) and end (frame) of the advertisement segment as the beginning and end of the advertisement if the advertisement candidate segment is determined as the advertisement segment (Operation 192).

To be more specific, if the threshold comparator 170 determines that the extracted characteristics of the acoustic shot are larger than the characterizing thresholds, the advertisement section determiner 172 determines the advertisement candidate segment to be the advertisement segment, determines the beginning and end of the advertisement segment as the beginning and end of the advertisement, and outputs the result obtained by the determination via an output terminal OUT9. However, if the threshold comparator 170 determines that the extracted characteristics of the acoustic shot are not larger than the characterizing thresholds, the advertisement section determiner 172 does not determine the advertisement candidate segment to be the advertisement segment, and outputs the result obtained by the determination via the output terminal OUT9. In that case, the advertisement section determiner 172 determines that the advertisement candidate segment has no advertisement section (operation 194).

FIG. 17 is a block diagram illustrating the advertisement segment determiner 16 shown in FIG. 1 according to another embodiment of the present invention. The advertisement segment determiner 16B includes a threshold comparator 200, a subtitle checking unit 202, and an advertisement section determiner 204.

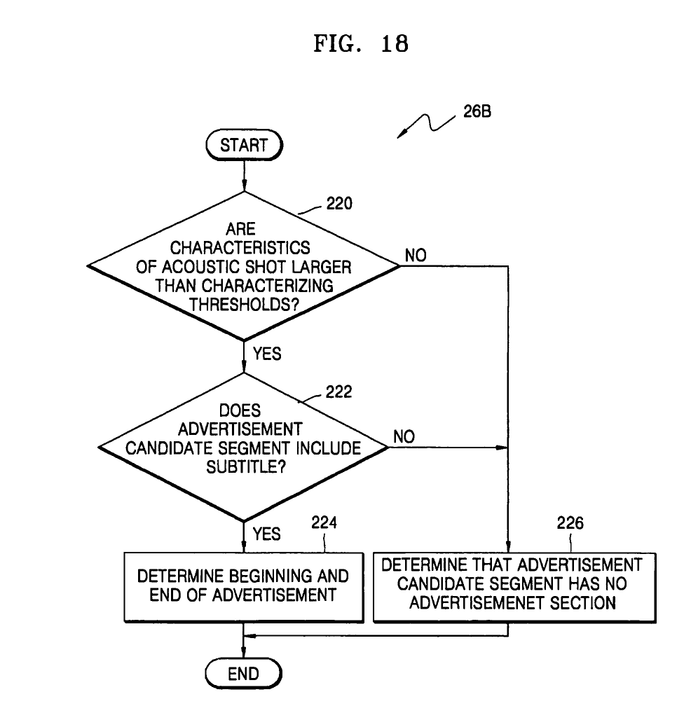

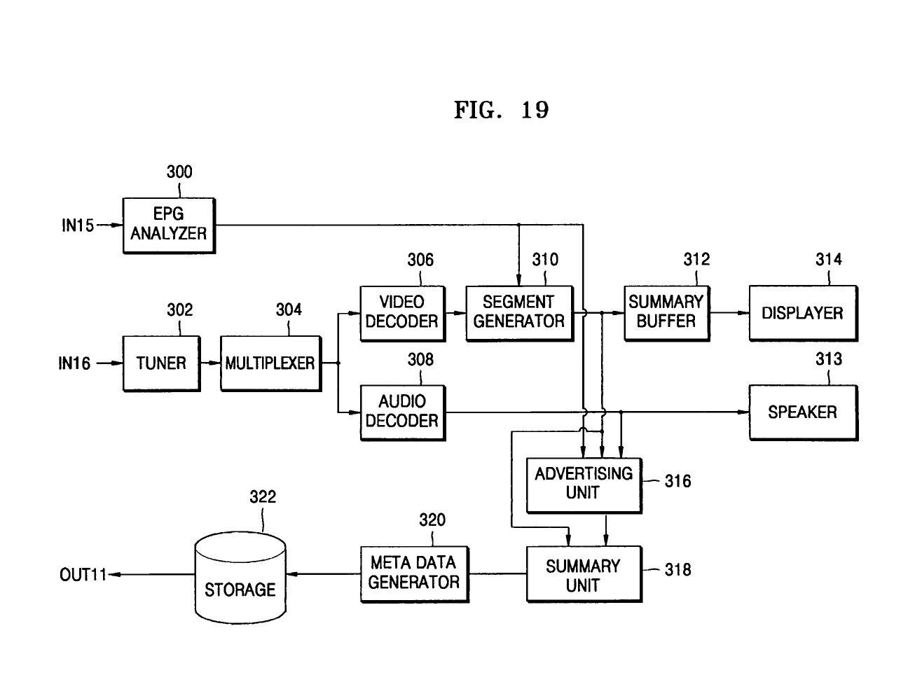

FIG. 18 is a flowchart illustrating Operation 26 shown in FIG. 2 according to another embodiment of the present invention. The flowchart includes determining a beginning and end of an advertisement based on the comparison of characteristics of an acoustic shot and characterizing thresholds and existence of the subtitle (Operations 220 through 226).

The threshold comparator 200 compares the characteristics of the acoustic shot extracted from the acoustic shot characteristic extractor 14 with characterizing thresholds received via an input terminal IN13, and outputs the results obtained by the comparison to the subtitle checking unit 202 (Operation 220). That is, the threshold comparator 200 determines whether the extracted characteristics of the acoustic shot are larger than the characterizing thresholds.

The subtitle checking unit 202 checks whether the advertisement candidate segment received from the advertisement candidate segment detector 12 via the input terminal IN14 includes the subtitle in response to the result obtained by the comparison (Operation 222). To be more specific, if the extracted characteristics of the acoustic shot are determined to be larger than the characterizing thresholds, the subtitle checking unit 202 determines whether the advertisement candidate segment includes the subtitle.

The advertisement section determiner 204 determines that the advertisement candidate segment received via the input terminal IN14 is an advertisement segment in response to the result obtained by the checking, and determines a beginning (frame) and end (frame) of the advertisement segment as the beginning and end of the advertisement, determines an end of the detected subtitle used to check whether the subtitle is included in the advertisement candidate segment in the subtitle checking unit 202 as the end of the advertisement, and outputs the result obtained by the determination to an output terminal OUT10 (Operation 224).

To be more specific, if the subtitle checking unit 202 determines that the advertisement candidate segment includes the subtitle, the advertisement section determiner 204 determines the advertisement candidate segment to be the advertisement segment, determines the beginning and end of the advertisement segment as the beginning and end of the advertisement, determines an end of the detected subtitle to be an end of the advertisement, and outputs the result obtained by the determination via the output terminal OUT10. However, if the subtitle checking unit 202 determines that the advertisement candidate segment does not include the subtitle, the advertisement section determiner 204 does not determine the advertisement candidate segment to be the advertisement segment, and outputs the result obtained by the determination via the output terminal OUT10. In this case, the advertisement section determiner 204 determines that the advertisement candidate segment has no advertisement section (Operation 226).

The threshold comparator 170 or 220 illustrated in FIG. 15 or 17 compares each of the extracted characteristics ACCR, MCR, and MDS of the acoustic shot with each of the characterizing thresholds TACCR, TMCR, and TMDS. In cases in which the extracted characteristic ACCR of the acoustic shot is larger than the characterizing threshold TACCR, the extracted characteristic MCR of the acoustic shot is larger than the characterizing threshold TMCR, and the extracted characteristic MDS of the acoustic shot is larger than the characterizing threshold TMDS, the extracted characteristics of the acoustic shot are determined to be larger than the characterizing thresholds.

The embodiments illustrated in FIGS. 15 and 16 are applied to an advertisement without a subtitle, and the embodiments illustrated in FIGS. 17 and 18 are applied to an advertisement having a subtitle.

The constitution and the operation of the apparatus used to detect the advertisement from a moving-picture according to an embodiment of the present invention will now be described in detail.

FIG. 19 is a block diagram of an apparatus used to detect an advertisement from a moving-picture according to an embodiment of the present invention. Referring to FIG. 19, the apparatus comprises an EPG analyzer 300, a tuner 302, a multiplexer MUX 304, a video decoder 306, an audio decoder 308, a segment generator 310, a summary buffer 312, a speaker 313, a displayer 314, an advertising unit 316, a summary unit 318, a meta data generator 320, and a storage 322.

The segment generator 310 is identical to the segment generator 10 illustrated in FIG. 11 and, accordingly, its detailed description is omitted. The advertising unit 316 can be realized as the advertisement candidate segment detector 12, the acoustic shot characteristics extractor 14, and the advertisement segment determiner 16 as illustrated in FIG. 1, or as only the advertisement candidate segment detector 12.

The EPG analyzer 300 analyzes EPG information extracted from an EPG signal received via an input terminal IN15, and outputs the result obtained by the analysis to the segment generator 310 and the acoustic shot characteristics extractor 14 of the advertising unit 316. The EPG signal can be separately provided via the Internet and included in a television broadcasting signal. In this case, a visual component of the moving-picture received by the segment generator 310 includes the EPG information, and an acoustic component of the moving-picture received by the acoustic shot characteristics extractor 14 of the advertising unit 316 includes the EPG information. The tuner 302 tunes the television broadcasting signal via an input terminal IN16, and outputs the obtained result to the MUX 304. The MUX 304 outputs a video component obtained from the result to the video decoder 306, and an audio component obtained from the result to the audio decoder 308.

The video decoder 306 decodes the video component received from the MUX 304, and outputs the result obtained by the decoding to the segment generator 310 as the visual component of the moving-picture. Similarly, the audio decoder 308 decodes the audio component received from the MUX 304, and outputs the result obtained by the decoding to the characteristics extractor 14 of the advertising unit 316 and the speaker 313 as the acoustic component of the moving-picture.

The visual component of the moving-picture includes both the visual component and the EPG information included in the television broadcasting signal, and the acoustic component of the moving-picture includes both the acoustic component and the EPG information included in the television broadcasting signal.

Meanwhile, when the advertising unit 316 is realized as the advertisement candidate segment detector 12, the summary unit 318 removes the advertisement candidate segment received from the advertisement candidate segment detector from segments generated in the segment generator 310, and outputs the result obtained by the removal to the meta data generator 320 as a summary result of the moving-picture. Alternatively, when the advertising unit 316 is realized as the advertisement candidate segment detector 12, the acoustic shot characteristics extractor 14, the advertisement segment determiner 16, the summary unit 318 removes the advertisement segment received from the advertisement segment determiner 16 of the advertising unit 316 from segments generated in the segment generator 310, and outputs the result obtained by the removal to the meta data generator 320 as a summary result of the moving-picture. The meta data generator 320 receives the summary result of the moving-picture from the summary unit 318, generates meta data of the input summary result of the moving-picture, i.e. property data, and outputs the generated meta data along with the summary result of the moving-picture to the storage 322. In this case, the storage 322 stores the meta data generated in the meta data generator 320 along with the summary result of the moving-picture, and outputs the results obtained by the storing via an output terminal OUT11.

The summary buffer 312 buffers the segment received from the segment generator 310, and outputs the result obtained by the buffering to the displayer 314. To this end, the segment generator 310 outputs previously generated segments to new segments every time new segments are generated to the summary buffer 312. The displayer 314 displays the result obtained by the buffering input from the summary buffer 312.

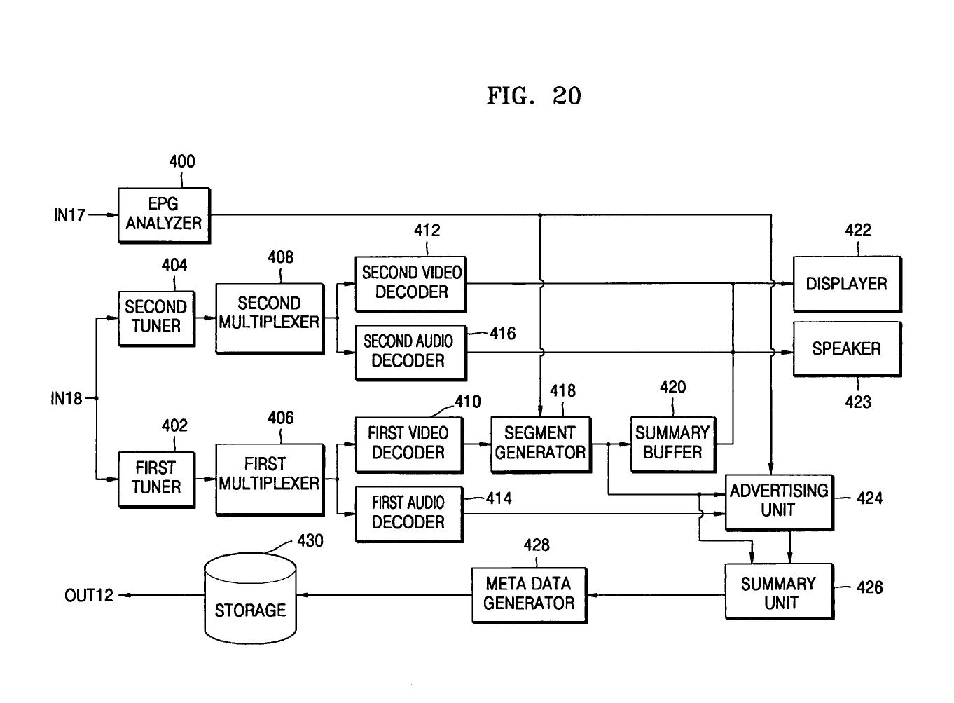

FIG. 20 is a block diagram illustrating an apparatus used to detect an advertisement from a moving-picture according to another embodiment of the present invention. Referring to FIG. 20, the apparatus comprises an EPG analyzer 400, first and second tuners 402 and 404, first and second multiplexers MUXs 406 and 408, first and second video decoders 410 and 412, first and second audio decoders 414 and 416, a segment generator 418, a summary buffer 420, a displayer 422, a speaker 423, an advertising unit 424, a summary unit 426, a meta data generator 428, and a storage 430.

The EPG analyzer 400, the segment generator 418, the summary buffer 420, the displayer 422, the speaker 423, the advertising unit 424, the summary unit 426, the meta data generator 428, and the storage 430 perform the same function as those of the EPG analyzer 300, the segment generator 310, the summary buffer 312, the speaker 313, the displayer 314, the advertising unit 316, the summary unit 318, the meta data generator 320, and the storage 322 illustrated in FIG. 19. The first and second tuners 402 and 404, the first and second multiplexers MUXs 406 and 408, the first and second video decoders 410 and 412, and the first and second audio decoders 414 and 416 perform the same function as those of the tuner 302, the multiplexer MUX 304, the video decoder 306, and the audio decoder 308 illustrated in FIG. 19, thus their detailed descriptions are omitted.

The apparatus illustrated in FIG. 20 includes two television broadcasting receiving paths, which is different from the apparatus illustrated in FIG. 19. One of the two television broadcasting receiving paths includes the second tuner 404, the second MUX 408, the second video decoder 412, and the second audio decoder 416, and is used to watch a television broadcasting via the displayer unit 422 and the speaker 423. The second of the two television broadcasting receiving paths includes the first tuner 402, the first MUX 406, the first video decoder 410, and the first audio decoder 414, and is used to store the summary of the moving-picture.

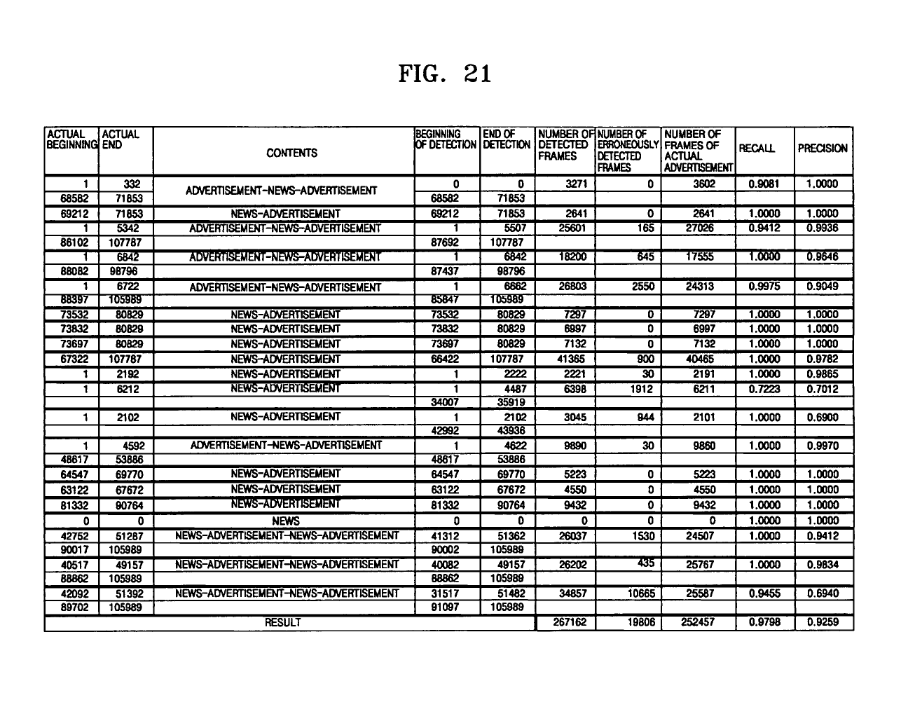

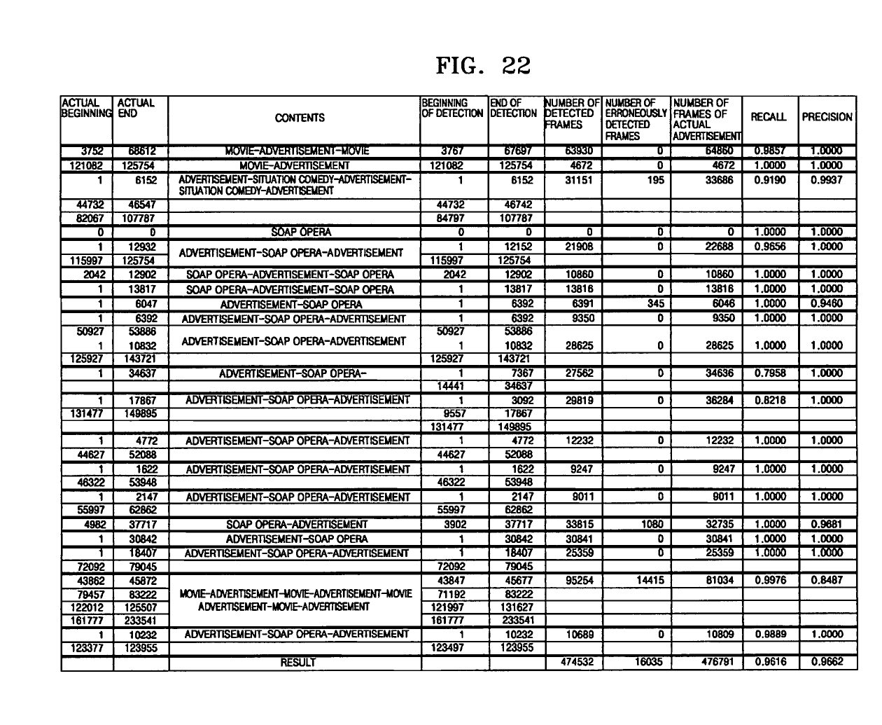

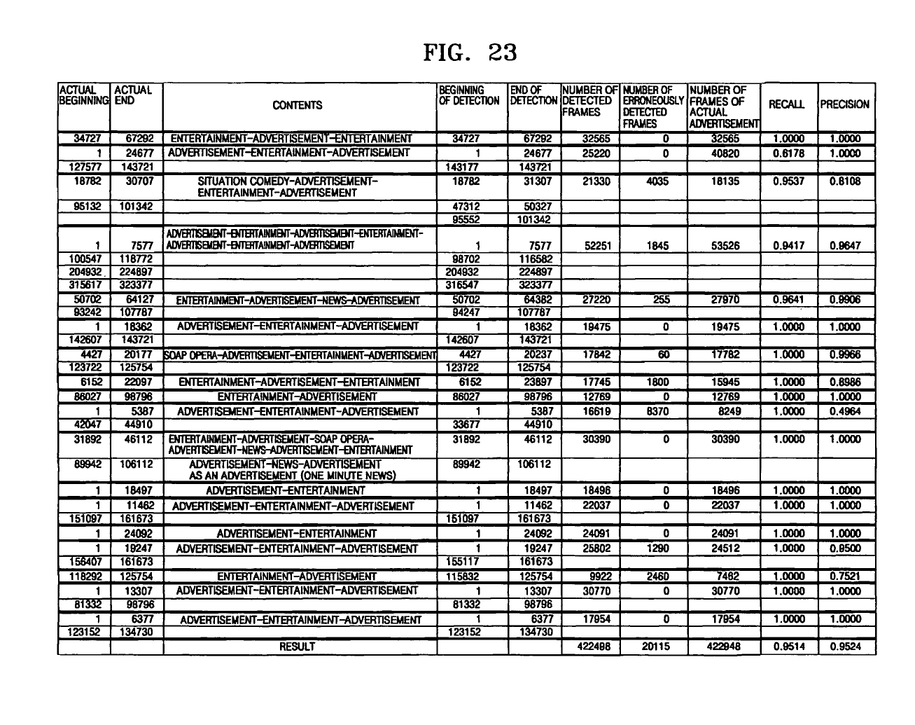

FIGS. 21 through 23 are tables illustrating the performance of the apparatus and method of detecting an advertisement from the moving-picture according to an embodiment of the present invention. FIG. 21 is a table illustrating the performance of the apparatus in a case in which the contents are advertisements and news, FIG. 22 is a table illustrating the performance of the apparatus in a case in which the contents are movies, advertisements, situation comedies, and soap operas, and FIG. 23 is a table illustrating the performance of the apparatus in a case in which the contents are entertainments, advertisements, situation comedies, news, and soap operas.

In addition to the above-described embodiments, the method of the present invention can also be implemented by executing computer readable code/instructions in/on a medium, e.g., a computer readable medium. The medium can correspond to any medium/media permitting the storing and/or transmission of the computer readable code. The code/instructions may form a computer program.

The computer readable code/instructions can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code/instructions is stored/transferred and executed in a distributed fashion. The computer readable code/instructions may be executed by one or more processors.

As described above, the apparatus and method of detecting an advertisement included in a moving-picture, and a computer-readable recording medium storing a computer program to control the apparatus, search an advertisement segment using a visual component of the moving-picture and acoustic information and subtitle information, thereby accurately detecting an advertisement section in a television moving-picture of a variety of types which may not include a black frame. A segment is generated based on the color similarity of shots, thereby increasing the possibility that a high cut rate results in an advertisement, which makes definition of the high cut rate easier to achieve. The detected advertisement of the moving-picture is removed from the moving-picture, thereby improving a summary function of the moving-picture, i.e., indexing and searching moving-pictures based on their content. Also, when users do not wish to watch the detected advertisement of the moving-picture, the detected advertisement can be skipped. An advertisement for television broadcasting can be removed using an authoring tool provided for content providers.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus used to detect an advertisement in a moving-picture, the apparatus comprising:
a segment generator to detect a component of a visual event from a visual component of the moving-picture, to combine or divide shots based on the component of the visual event, and to output a result obtained by the combination or division of shots as a segment; and
an advertisement candidate segment detector to detect an advertisement candidate segment using a rate of shots of the segment;
wherein the visual event denotes an effect included in a scene conversion in the moving-picture, the advertisement candidate segment denotes a segment to be a candidate of an advertisement segment, and the advertisement segment denotes a segment having an advertisement as its content.

2. The apparatus of claim 1, wherein the segment generator comprises:
a visual event detector to detect the component of the visual event from the visual component;
a scene conversion detector to detect the scene conversion from the visual component and to generate time and color information of a shot which is a same scene section using a result obtained by the scene conversion detection; and
a visual shot combiner/divider to analyze similarity of the shots using the color information of the shots received from the scene conversion detector, and to combine or divide the shots using the analyzed similarity and the component of the visual event.

3. The apparatus of claim 2, wherein the visual event detector detects a single color frame in a fade effect from the visual component, and outputs the detected single color frame as a component of the visual event,
wherein the visual event is the fade effect.

4. The apparatus of claim 2, wherein the visual event is one of a fade effect, a dissolve effect, and a wipe effect.

5. The apparatus of claim 2, wherein the visual shot combiner/divider comprises;
a buffer to store the color information of the shots received from the scene conversion detector;
a similarity calculator to read color information of a first integral number pertaining to a search window among the color information stored in the buffer, and to calculate color similarity of the shots using the read color information; and
a combiner to compare the color similarity and a similarity threshold, and to combine the compared two shots in response to the result obtained by the comparison of the two shots.

6. The apparatus of claim 5, wherein the visual shot combiner/divider further comprises a divider to divide a result obtained by the combination of the two shots in the combiner based on the component of the visual event in response to the result obtained by the combination including the component of the visual event.

7. The apparatus of claim 5, wherein the similarity calculator calculates the color similarity as
$$Sim ( {H}_{1} , {H}_{2} ) = {\sum }_{n = 1}^{N} min [ {H}_{1} ( n ) , {H}_{2} ( n ) ]$$
wherein Sim (H1, H2) denotes the color similarity of the two shots, H1(n) and H2(n) denote color histograms of the two shots, respectively, N denotes a histogram level, and min(x,y) denotes a minimum value of x and y.

8. The apparatus of claim 5, wherein the first integral number, which is the size of the search window, is determined according to EPG information.

9. The apparatus of claim 2, wherein the advertisement candidate segment detector comprises:
a rate calculator to calculate the rate of shots in the segment input from the segment generator using the scene conversion detected in the scene conversion detector;
a rate comparator to compare the shot rate and a rate threshold; and
an advertisement candidate segment output unit to output the segment received in the rate calculator as the advertisement candidate segment in response to the result obtained by the comparison in the rate comparator.

10. The apparatus of claim 9, wherein the rate calculator calculates the shot rate as
$$S C R = \frac{S}{N \#}$$
wherein SCR (Shots Change Rate within the segment shot) denotes the shot rate, S denotes a number of shots included in the segment generated in the segment generator, and N# denotes a number of frames included in the segment generated in the segment generator.

11. The apparatus of claim 9, wherein the advertisement candidate segment output unit combines or extends the advertisement candidate segments.

12. The apparatus of claim 11, wherein the advertisement candidate segment output unit combines the successive advertisement candidate segments.

13. The apparatus of claim 11, wherein the advertisement candidate segment output unit regards the advertisement non-candidate segment as an advertisement candidate segment, and extends the region of the advertisement candidate segment, in response to an advertisement non candidate segment being included in the advertisement candidate segments;
wherein the advertisement non-candidate segment indicates a segment which is not a candidate of the advertisement segment.

14. The apparatus of claim 1, further comprising:
an acoustic shot characteristic extractor to extract acoustic shot characteristics using the component of an acoustic event detected from an acoustic event of the moving-picture and the segment generated in the segment generator; and
an advertisement segment determiner to determine the advertisement candidate segment to be the advertisement segment using the extracted acoustic shot characteristics;
wherein the acoustic event comprises a sound used to identify the acoustic component.

15. The apparatus of claim 14, wherein the acoustic shot characteristic extractor comprises:
an audio characteristic value generator to extract audio features from the acoustic component by frames, and to output an average and a standard deviation of the audio features of a second integer number of frames as audio characterizing values;
an acoustic event detector to detect the component of the acoustic event using the audio characteristic values; and
a characteristic extractor to extract the acoustic shot characteristics using the detected component of the acoustic event and the segment generated in the segment generator.

16. The apparatus of claim 15, wherein the audio characteristic value generator comprises:
a frame unit divider to divide the acoustic component of the moving-picture into frames of a predetermined time;
a feature extractor to extract each audio feature of the divided frames; and
an average/standard deviation calculator to calculate the average and the standard deviation of the audio features of the second integer number of frames in the feature extractor, and to output the calculated average and standard deviation as the audio characteristic values.

17. The apparatus of claim 15, wherein the audio features comprise MFCC (Mel-Frequency Cepstral Coefficient), Spectral Flux, Centroid, Rolloff, ZCR, Energy, or Picth information, or a combination thereof.

18. The apparatus of claim 15, wherein the component of the acoustic event comprises music, voice, surrounding noise, mute, or a combination thereof.

19. The apparatus of claim 15, wherein the feature extractor outputs at least one of a rate of the component of the acoustic event, a portion of music among components of the acoustic event, and maximum time duration of a sequence comprising components of the same acoustic event as the acoustic shot characteristics in units of the segment generated in the segment generator.

20. The apparatus of claim 19, wherein the rate of the component of the acoustic event, the portion of music among components of the acoustic event, and maximum time duration of a sequence comprising components of the same acoustic event are calculated as
$$ACCR = \frac{{\sum }_{j = 2}^{J} H [ C ( j ) , C ( j - 1 ) ]}{J}$$
wherein ACCR (Audio Class Change Rate within the segment shot) denotes the rate of the component of the acoustic event, J denotes a number of audio clips included in the segment generated in the segment generator, the clip is a minimum unit classified as an acoustic component, and C(j) denotes a type of components of the acoustic event of a j^{th} audio clip, in which if C(j)≠C(j−1), H[C(j),C(j−1)] is ‘1’, and if C(j)=C(j−1), H[C(j),C(j−1)] is ‘0’, then
$$MCR = \frac{{\sum }_{j = 1}^{J} SM [ C ( j ) , '' Music '' ]}{J}$$
wherein MCR (Music Class Ratio within the segment shot) denotes the portion of music among components of the acoustic event, and M denotes the number of sequences comprising components of the same acoustic event included in the segment generated in the segment generator, in which if C(j)=“Music”, SM[C(j), “Music”] is ‘1’, and if C(j)≠“Music”, SM[C(j), “Music”] is ‘0’, then
$$MDS = \frac{{max}_{1 \leq m \leq M} [ {d}_{s} ( m ) ]}{J}$$
wherein MDS (Max-Duration of the Sequence with same audio classes within the segment shot) denotes the maximum time duration, and ds(m) denotes the number of audio clips of an m^{th} sequence.

21. The apparatus of claim 14, wherein the advertisement segment determiner comprises:
a threshold comparator to compare the extracted acoustic shot characteristics and characteristic thresholds; and
an advertisement section determiner to determine the advertisement candidate segment to be the advertisement segment in response to the result obtained by the comparison in the threshold comparator, and to output a beginning and end of the advertisement segment as a beginning and end of the advertisement.

22. The apparatus of claim 14, wherein the advertisement segment determiner comprises:
a threshold comparator to compare the extracted acoustic shot characteristics and characteristic thresholds;
a subtitle checking unit to check whether the advertisement candidate segment includes a subtitle in response to the result obtained by the comparison; and
an advertisement section determiner to determine the advertisement candidate segment to be the advertisement segment in response to the result obtained by the comparison in the subtitle checking unit, and to determine and output a beginning and end of the advertisement segment as a beginning and end of the advertisement;
wherein the advertisement includes the subtitle.

23. The apparatus of claim 1, wherein a result obtained by removing the advertisement candidate segment from segments generated in the segment generator is used as a result obtained by summarizing the moving-picture.

24. The apparatus of claim 14, wherein a result obtained by removing the advertisement segment determined in the advertisement segment determiner from the segments generated in the segment generator is used as the result obtained by summarizing the moving-picture.

25. The apparatus of claim 23, wherein meta data of the result obtained by summarizing the moving-picture is generated, and the generated meta data is stored along with the result obtained by summarizing the moving-picture.

26. The apparatus of claim 1, wherein the visual component of the moving-picture includes both the visual component and EPG information included in a television broadcasting signal.

27. The apparatus of claim 14, wherein the acoustic component of the moving-picture includes both the acoustic component and EPG information included in the television broadcasting signal.

28. A method of detecting an advertisement in a moving-picture, the method comprising:
detecting a component of a visual event from a visual component of the moving-picture, combining or dividing shots based on the component of the visual event, and determining a result obtained by the combination or division of shots as a segment; and
detecting an advertisement candidate segment using a rate of shots of the segment;
wherein the visual event denotes an effect included in a scene conversion in the moving-picture, the advertisement candidate segment denotes a segment to be a candidate of an advertisement segment, and the advertisement segment denotes a segment having an advertisement as its content.

29. The method of claim 28, wherein the determining of the result comprises:
detecting the component of the visual event from the visual component;
detecting the scene conversion from the visual component and generating time and color information of a shot which is a same scene section using a result obtained by the scene conversion detection; and
analyzing similarity of the shots using the color information of the shots, and combining or dividing the shots using the analyzed similarity and the component of the visual event.

30. The method of claim 29, wherein the detecting of the advertisement candidate segment comprises:
calculating a rate of the shot in the determined segment using the detected scene conversion;
determining whether the rate of the shot is higher than a threshold; and
determining the segment used to calculate the rate of the shot to be the advertisement candidate segment in response to the rate of the shot being higher than the threshold.

31. The method of claim 28, further comprising:
extracting acoustic shot characteristics using the component of an acoustic event detected from an acoustic event of the moving-picture and the segment; and
determining the advertisement candidate segment to be the advertisement segment using the extracted acoustic shot characteristics;
wherein the acoustic event is a type of sound used to identify the acoustic component.

32. The method of claim 31, wherein the extracting of the acoustic shot characteristics comprises:
extracting audio features from the acoustic component by frames, and outputting an average and a standard deviation of the audio features of a second integer number of frames as audio characterizing values;
detecting the component of the acoustic event using the audio characteristic values; and
extracting the acoustic shot characteristics using the detected component of the acoustic event and the segment.

33. The method of claim 31, wherein the determining of the advertisement segment determiner comprises:
determining whether the extracted acoustic shot characteristics are larger than characteristic thresholds; and
determining the advertisement candidate segment to be the advertisement segment, and outputting a beginning and an end of the advertisement segment as a beginning and an end of the advertisement, in response to the extracted acoustic shot characteristics being larger than the characteristic thresholds.

34. The method of claim 31, wherein the advertisement segment determiner comprises:
determining whether the extracted acoustic shot characteristics are larger than characteristic thresholds;
determining whether the advertisement candidate segment includes a subtitle in response to the extracted acoustic shot characteristics being larger than the characteristic thresholds; and
determining the advertisement candidate segment to be the advertisement segment, and determining a beginning of the advertisement segment as a beginning of the advertisement, and determining and outputting an end of the detected subtitle as an end of the advertisement, in response to the advertisement candidate segment including the subtitle;
wherein the advertisement includes the subtitle.

35. At least one computer readable medium storing instructions that control at least one processor to perform a method a method of detecting an advertisement in a moving-picture, wherein the method comprises:
detecting a component of a visual event from a visual component of the moving-picture, combining or dividing shots based on the component of the visual event, and determining a result obtained by the combination or division of shots as a segment; and
detecting an advertisement candidate segment using a rate of shots of the segment;
wherein the visual event denotes an effect included in a scene conversion in the moving-picture, the advertisement candidate segment denotes a segment to be a candidate of an advertisement segment, and the advertisement segment denotes a segment having an advertisement as its content.

36. The computer-readable recording medium of claim 35, wherein the method further comprises:
extracting acoustic shot characteristics using the component of an acoustic event detected from an acoustic event of the moving-picture and the segment; and
determining the advertisement candidate segment to be the advertisement segment using the extracted acoustic shot characteristics,
wherein the acoustic event is a sound used to identify the acoustic component.

37. An apparatus used to detect an advertisement in a moving-picture, the apparatus comprising:
a segment generator to detect a visual event from a visual component of the moving-picture, to combine or divide shots according to the visual event, and to output a result of the combination or division as a segment;
wherein an advertisement candidate segment is determined according to a rate of shots of the segment.

38. An apparatus used to detect an advertisement in a moving-picture, the apparatus comprising:
a segment generator to generate a segment of the moving-picture according to visual events detected in the moving picture; and
an advertisement candidate segment detector to detect an advertisement segment according to a rate of shots of the segment;
wherein the shots are combined or divided according to the detected visual events.

39. A method of detecting an advertisement in a moving-picture, the method comprising:
detecting a visual event from a visual component of the moving-picture;
combining or dividing shots according to the visual event; and
outputting a result of the combination or division as a segment;
wherein an advertisement candidate segment is determined according to a rate of shots of the segment.

40. A method of detecting an advertisement in a moving-picture, the method comprising:
generating a segment of the moving-picture according to visual events detected in the moving picture; and
detecting an advertisement segment according to a rate of shots of the segment;
wherein the shots are combined or divided according to the detected visual events.
